(19) United States
(12) Patent Application Publication
(10) Pub. No.: US 2009/0100365 A1
(43) Pub. Date: Apr. 16, 2009

(54) ZOOMING TRANSITIONS

(75) Inventor: Fredrik Sjolin, Ronneby (SE)

Correspondence Address: RENNER OTTO BOISSELLE & SKLAR, LLP, 1621 EUCLID AVENUE, NINETEENTH FLOOR, CLEVELAND, OH, 44115, US

(73) Assignee: UIQ TECHNOLOGY AB, Ronneby (SE)

(21) Appl. No.: 12/298,182

(22) PCT Filed: Jun. 21, 2007
(86) PCT No.: PCT/EP07/56191

§ 371 Date: Oct. 23, 2008

(30) Foreign Application Priority Data
Jun. 26, 2006 (GB) 0612636.1

(51) Int. Cl. G06F 3/048

(52) U.S. Cl. 715/765

(57) ABSTRACT

The present invention relates to a solution for facilitating user interface to a machine, comprising a solution for resizing selected objects to a first size in a graphical user interface and resizing not selected objects to a second size, wherein the first and second size are different from each other and from the size before selection.

### TECHNICAL FIELD

The present invention relates to a solution for facilitating user interface in computational devices and in particular to facilitating navigation in a user interface.

### BACKGROUND OF THE INVENTION

We are becoming more and more dependent on computational devices in our lives and these devices provide a complex environment to operate in. Graphical user interfaces have been developed in order to facilitate navigation in content on the computational device. To further facilitate the interaction special effects have been developed to allow the user to more easily locate information and/or navigate in complex or information rich environments. For instance effects relating to navigation in file structures or for selecting a particular file in a file manager wherein a selected object changes its color, grayscale, or similarly or is resized as compared to other non-selected objects and thus the user will more easily see which object that has been selected. This facilitates the interaction between the user and the machine.

However, these effects may sometimes not be enough, for instance considering laptops, mobile phone, or personal digital assistants where a small display unit may be utilized and often used in environments of not so optimal light conditions: it can then be difficult to see the objects on the display unit.

It is an object of the present invention to provide a solution for further facilitating interfacing in this field of technology.

### SUMMARY OF THE INVENTION

This is provided for in a number of aspects, in which a first is provided: a user device, comprising a processing unit configured to run a graphical user interface, i.e. GUI;
a memory;
an graphics handling program for receiving and handling events related to user interface;
a display unit;
wherein the processing unit is arranged to receive signals indicative of user interface selections and use the graphics handling program to resize a selected object having an initial size and presented in the GUI to a first size and to resize non-selected objects in the GUI to a second size; the first and second sizes being different from each other and from the initial size.

The device may further comprise a communication interface for wireless communication with an infrastructure gateway, e.g. a mobile phone base station, a WiFi access point, or a Wimax gateway.

The processing unit may be arranged to change the selected objects colour, light intensity, or grey scale. The processing unit may be arranged to use scalable vector graphics during transition from one size to another size.

The processing unit may be arranged to make a transition from one size to another size during a set time range. The set time may be in the range of a few microseconds to 5 seconds, and preferably 1.5 seconds.

The processing unit may be arranged to retain the size of the resized objects until a new object is selected. The processing unit may be arranged to keep the size of the resized objects for a period of time in the range of 0 seconds to 60 seconds.

Another aspect of the present invention, a method for facilitating user interaction with a machine is provided, comprising the steps of:
receiving signals indicate of user interaction;
selecting a stored object determined from the received signals;
resizing to a first size the size of the selected object in a graphical user interface, i.e. GUI.
resizing to a second size of a object not selected;
wherein the first and second sizes are different from each other and from the size before resizing.

Yet another aspect of the present invention, a computer program product for facilitating user interaction in a device, comprising instructions sets for:
receiving signals indicate of user interaction;
selecting a stored object determined from the received signals;
resizing to a first size the size of the selected object in a graphical user interface, i.e. GUI.
resizing to a second size objects not selected;
wherein the first and second sizes are different from each other and from the size before resizing.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates schematically a device according to the present invention;

FIG. 2 illustrates schematically an example embodiment of the present invention;

FIG. 3 illustrates schematically an example embodiment of the present invention; and

FIG. 4 illustrates schematically a method according to the present invention;

### DETAILED DESCRIPTION OF PREFERRED EMBODIMENTS

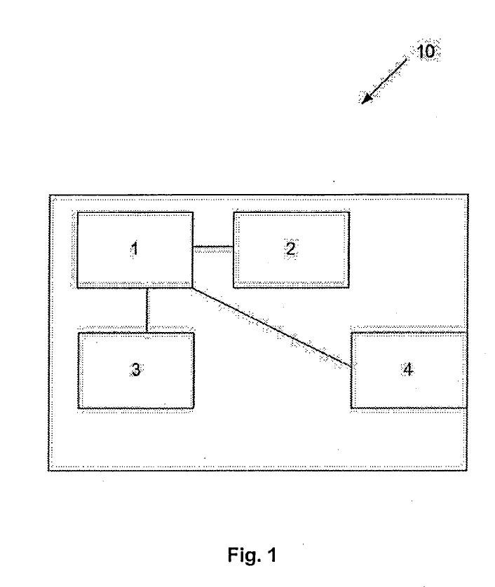

In FIG. 1, reference numeral 10 generally indicate a computational device according to the present invention, where the device may be a desktop or laptop computers, personal digital assistant (PDA), mobile phone, smart phone, digital camera, or digital music player (e.g. MP3 players), or combinations of these. The device 10 comprises a processing unit 1, a volatile and/or non-volatile memory 2, a user interface unit 3, and optionally one or several communication interfaces 4.

The processing unit may for instance be a microprocessor, a computer processor, a DSP (Digital Signal Processor), an FPGA (Field Programmable Gate Array), an ASIC (Application Specific Integrated Circuit), or any other suitable processing unit capable of handling software instructions and/or computational processing.

The memory 2 may comprise any suitable memory known to the skilled person, such as for instance RAM, Hard disk, Flash memory, Secure Digital (SD) of different versions, memory stick of different versions or variations, and EEPROM.

The user interface 3 is arranged to control display of information in a GUI (Graphical User Interface) display. The information may be provided by the processing unit 1. The user interface unit may be built into the processing unit.

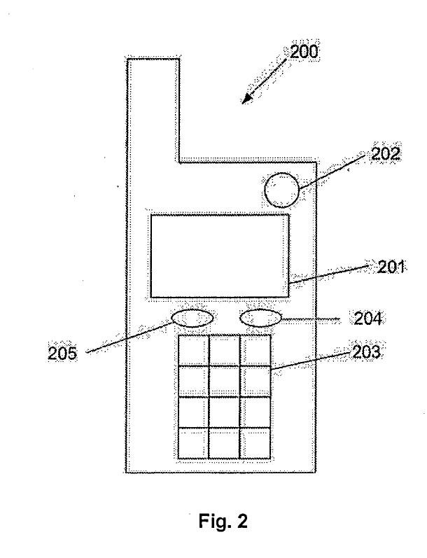

The user interface unit is connected to user interfaces such as a display unit (not shown), a keyboard or similar control unit(s), and optionally other user interface equipment depending on type of device and application area (e.g. a mobile phone will have a microphone and loudspeaker connected). This will be discussed later in relation to FIG. 2.

Optionally, a communication interface 4 may be provided. This communication interface may for instance be using a packet based interface protocol over any suitable physical communication channel. The physical communication channel may be wired or wireless depending on type of device. For instance using a desktop or laptop computer, the interface is often wired through for instance an Ethernet connection or it may be wireless using Ethernet over some wireless protocol (e.g. WiFi, Wimax, Wibro, or some other protocol based on any wireless area network protocol (e.g. PAN, PAN, LAN (WLAN), or RAN): IEEE 802.11, 802.15, 802.16, 802.20, 802.22 series of protocols); whereas in a mobile phone the physical channel may be for instance EVDO, CDMA, EDGE, GPRS, HSDPA, or UMTS for instance. The communication channel may also be of a circuit switched character (e.g. GSM) or a combination of these.

As one example, one may mention the use in a mobile phone with a user interface. FIG. 2 shows an example of a mobile phone 200 with a display unit 201 (e.g. controlled by the interface unit 3 of FIG. 1), a keypad 203 with a plurality of interface buttons (e.g. the numbers 0-9 and a * and # button), and preferably one or several control buttons (e.g. Ok, erase, menu, selection, quick interface, and so on: some of these functions may be incorporated into one button) 204, 205. The phone may also be provided with a camera 202. The phone is also provided with a microphone and loudspeaker; however, these are not shown. Furthermore, the phone may also be provided with other types of physical interfaces (not shown), e.g. for hands free (wired or wireless) communication link, battery charger connection, removable memory media, and so on.

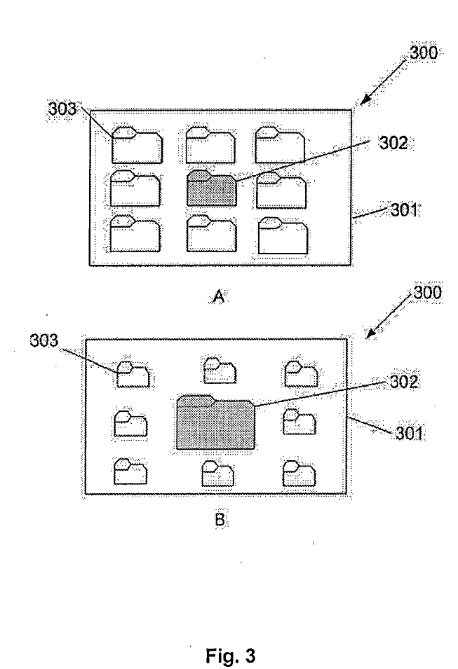

In FIG. 3, reference numeral 300 generally indicates a user interface display with a display area 301 comprising in this case schematically symbolized folders 302, 303 in a file structure. In FIG. 3A a folder 302 is to be selected and in FIG. 3B the selected folder 302 has been resized to be larger than the (normal sized) non-selected folders 303. Also in FIG. 3B the non-selected folders 303 have been resized to a smaller size in order to further emphasize the difference between the selected and non-selected folders. The display is preferably a graphical user interface (GUI). Selection of an object in the GUI may be made by clicking on the object using a selection tool (e.g. a cursor) or just moving the selection tool over the object or tapping with a tapping device (pen).

The selected object may also be resized to a smaller size than the original size and the non-selected objects will, in this situation, be resized to a larger size than the original size; however, it should be noted that other size combination may be used as long as the selected and non-selected objects have different sizes from each other and from the original sizes.

The non-selected objects may even be removed entirely in order to further emphasize the selected object.

In one embodiment the entire background may also shrink in size (or the entire application if the selection occurs within an application) leading to the effect of zooming away from the background (the visual effect may then be that a larger view of the background is seen; for instance if the entire screen view is shrunk information normally hidden outside the screen boundaries may be shown).

The transition from (for an observer) normal sized to resized may be performed during a time interval ranging from instantaneous to a few seconds (e.g. some micro seconds to 5 seconds) and preferably in the order of 1.5 seconds. The transition may be performed as a semi permanent transition, i.e. it last while the selection lasts, or the resize may be lasting during only a time interval, e.g. 0 seconds, a few seconds, or up to some minutes. These types of configurations may be settable through a user interface for setting and amending control parameters for display properties.

To even further enhance the effect the colour and/or grey scale of the selected object and/or non-selected objects may change together with the resizing.

An application using the solution according to the present invention, may use graphics handling formats, such as SVG (Scalable Vector Graphics), and/or built in graphics handling routines in the operative system, e.g. OpenGL, DirectX, and similar for providing a high quality scalable version of the object image by interfacing to graphics handling hardware units.

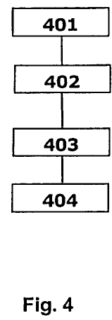

FIG. 4 illustrates a method according to the present invention, comprising the steps of:

401. Selecting an object in a file structure using a graphical user interface (GUI).

402. Resizing the object in the GUI to one size.

403. Resizing non-selected objects shown in the same GUI to another size.

404. Allowing the user to interact with the selected object.

An operative system for the device 1, 200 may be provided with a general application resource software with this type of feature for use in any type of application: the invention is not restricted to the file manager of the operative system but may be applicable also within applications such as word processors, image management programs, network management programs, and communication management programs.

It should be noted that the word “comprising” does not exclude the presence of other elements or steps than those listed and the words “a” or “an” preceding an element do not exclude the presence of a plurality of such elements. The invention can at least in part be implemented in either software or hardware. It should further be noted that any reference signs do not limit the scope of the claims, and that several “means”, “devices”, and “units” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

### DEFINITIONS AND ABBREVIATIONS

CDMA Code division multiple access
EDGE Enhanced Data rates for GSM Evolution
EVDO Evolution-Data Optimized
GPRS General Packet Radio Service
GUI Graphical User Interface
HSDPA High-Speed Downlink Packet Access
IEEE Institute of Electrical and Electronics Engineers
LAN Local Area Network
PAN Personal Area Network
RAN Regional Area Network
UMTS Universal Mobile Telecommunications System
WAN Wide Area Network
WLAN Wireless Local Area Network

1. A user device, comprising a processing unit configured to run a graphical user interface, i.e. GUI; a memory; an graphics handling program for receiving and handling events related to user interface; a display unit; wherein the processing unit is arranged to receive signals indicative of user interface selections and use the graphics handling program to resize a selected object of a plurality of selectable objects having an initial size and presented in the GUI to a first size, to resize non-selected objects in the GUI to a second size and to shrink the entire background of the GUI; the first and second sizes being different from each other and from the initial size.

2. The device according to claim 1, wherein the first size is smaller than the initial size and the second size is larger than the initial size.

3. The device according to claim 1, further comprising a communication interface for wireless communication with an infrastructure gateway, e.g. a mobile phone base station, a WiFi access point, or a Wimax gateway.

4. The device according to claim 1, wherein the processing unit is arranged to change the selected objects colour, light intensity, or grey scale.

5. The device according to claim 1, wherein the processing unit is arranged to use scalable vector graphics during transition from one size to another size.

6. The device according to claim 1, wherein the processing unit is arranged to make a transition from one size to another size during a set time range, wherein the set time is in the range of a few microseconds to 5 seconds, and preferably 1.5 seconds.

7. The device according to claim 1, wherein the processing unit is arranged to retain the size of the resized objects until a new object is selected.

8. The device according to claim 1, wherein the processing unit is arranged to keep the size of the resized objects for a period of time in the range of 0 seconds to 60 seconds.

9. A method for facilitating user interaction with a device, comprising the steps of: receiving signals indicate of user interaction; selecting a stored object of a plurality of selectable objects determined from the received signals; resizing to a first size the size of the selected object in a graphical user interface, i.e. GUI.—resizing to a second size of a object not selected; wherein the first and second sizes are different from each other and from the size before resizing, and—shrinking the entire background of the GUI.

10. A computer program product for facilitating user interaction in a device, comprising instructions sets for: receiving signals indicate of user interaction; selecting a stored object of a plurality of selectable objects determined from the received signals; resizing to a first size the size of a selected object in a graphical user interface, i.e. GUI.—resizing to a second size objects not selected; wherein the first and second sizes are different from each other and from the size before resizing, and—shrinking the entire background of the GUI.
